(19) United States
(12) Patent Application Publication
(10) Pub. No.: US 2024/0405337 A1
(43) Pub. Date: Dec. 5, 2024

(54) BATTERY PACK

(71) Applicant: HONDA MOTOR CO., LTD., Tokyo (JP)

(72) Inventors: Masaaki TATSUWAKI, Saitama (JP); Ryo ISHIZAKI, Saitama (JP); Ken YASUI, Saitama (JP)

(73) Assignee: HONDA MOTOR CO., LTD., Tokyo (JP)

(21) Appl. No.: 18/669,570

(22) Filed: May 21, 2024

(30) Foreign Application Priority Data
May 31, 2023 (JP) 2023-089879

(51) Int. Cl. H01M 50/249; B60K 1/00; B60K 1/04; H01M 10/613; H01M 10/625; H01M 10/6567; H01M 50/209; H01M 50/262

(52) U.S. Cl. CPC H01M 50/249; H01M 10/613; H01M 10/625; H01M 10/6567; H01M 50/209; H01M 50/262; B60K 2001/005; B60K 1/04; B60K 2001/0438; H01M 2220/20

(57) ABSTRACT

A battery pack includes: battery modules being arranged side by side in a horizontal direction; and a case including a cross member provided between the battery modules arranged side by side, in which the cross member includes: an upper cross member; a lower cross member; and a fixing portion abutting against a bottom surface of a case main body and fixing the upper cross member and the lower cross member to each other by a fastening member, in which the bottom surface of the case main body is integrally provided with at least one first protruding portion that protrudes downward and extends continuously in the horizontal direction, and the first protruding portion intersects the cross member at a position overlapping the fixing portion of the cross member when viewed in the upper-lower direction.

### CROSS REFERENCE TO RELATED APPLICATIONS

This application claims priority to Japanese Patent Application No. 2023-089879 filed on May 31, 2023, the content of which is incorporated herein by reference.

### TECHNICAL FIELD

The present invention relates to a battery pack attached under a floor of a vehicle body.

### BACKGROUND ART

In recent years, researches and developments have been conducted on a secondary battery (hereinafter, also referred to as a battery) that contributes to improvement in energy efficiency in order to allow more users to access affordable, reliable, sustainable, and advanced energy.

A large-capacity battery is mounted on an electric vehicle such as a battery type electric automobile. The battery is attached, for example, below a floor panel of a vehicle body in a state of being accommodated in a case, and a structure for protecting the battery from a load input due to collision is required when a curb, a flying stone, or the like collides with the case from below during traveling.

On the other hand, for example, in a vehicle body lower structure described in JP2021-138187A, a protective plate is disposed below a battery case, and a protrusion is provided on a bottom plate of the battery case or the protective plate at a position below an intermediate plate of a battery stack.

In JP2021-138187A, the protective plate is placed below the battery case to protect the battery stack, but this increases the number of parts and the weight of the vehicle. There is a demand for both battery protection and reduction in the number of parts or weight.

An object of the present invention is to provide a battery pack capable of achieving both protection of a battery module and reduction in the number of parts or weight.

### SUMMARY OF INVENTION

According to an aspect of the present invention, there is provided a battery pack to be attached under a floor of a vehicle body, including: battery modules each including a plurality of battery cells stacked in a first direction in a horizontal direction, the battery modules being arranged side by side at least two in a second direction orthogonal to the first direction in the horizontal direction; and a case accommodating the battery modules. The case includes: a case main body on which the battery modules are placed; and a cross member extending in the first direction inside the case and provided between at least two of the battery modules arranged side by side in the second direction. The cross member includes: an upper cross member; a lower cross member disposed below the upper cross member at a position overlapping the upper cross member when viewed in an upper-lower direction; and a fixing portion abutting against a bottom surface of the case main body and fixing the upper cross member and the lower cross member to each other by a fastening member. The bottom surface of the case main body is integrally provided with at least one first protruding portion that protrudes downward and extends continuously in the second direction, and the first protruding portion intersects the cross member at a position overlapping the fixing portion of the cross member when viewed in the upper-lower direction.

### BRIEF DESCRIPTION OF DRAWINGS

FIG. 1 is a perspective view of a battery pack 10 attached to a vehicle body 1.

FIG. 2 is an exploded perspective view of the battery pack 10.

FIG. 3 is a partial perspective view of a battery module 11 when viewed from a cover plate 15 side.

FIG. 4 is a top view of the battery module 11.

FIG. 5 is an enlarged perspective view of a cross member 50.

FIG. 6 is a top view showing an arrangement relationship between the cross member 50 and the battery module 11 on a front side and the battery module 11 on a rear side.

FIG. 7 is a cross-sectional view taken along a line A-A of FIG. 6.

FIG. 8 is a cross-sectional view taken along a line B-B of FIG. 6.

FIG. 9 is a top view of the battery pack 10 with a cover 22 removed.

FIG. 10 is a bottom view of the battery pack 10.

FIG. 11 is a cross-sectional view taken along a line C-C of FIG. 9.

FIG. 12 is a cross-sectional view taken along a line D-D of FIG. 9.

FIG. 13 shows the present embodiment (upper stage) in which a third protruding portion 327 is provided between a water jacket 70 and a rear frame 41, and a comparative example (lower stage) in which the third protruding portion 327 is provided directly below the rear frame 41.

### DESCRIPTION OF EMBODIMENTS

Hereinafter, a battery pack according to an embodiment of the present invention will be described with reference to the accompanying drawings. Note that the drawings are viewed from directions of reference numerals, and in the following description, directions such as front, rear, left, right, upper, and lower directions are described according to a direction viewed from a driver of a vehicle. In the drawings, a front side of the vehicle is denoted by Fr, a rear side thereof is denoted by Rr, a left side thereof is denoted by L, a right side thereof is denoted by R, an upper side thereof is denoted by U, and a lower side thereof is denoted by D.

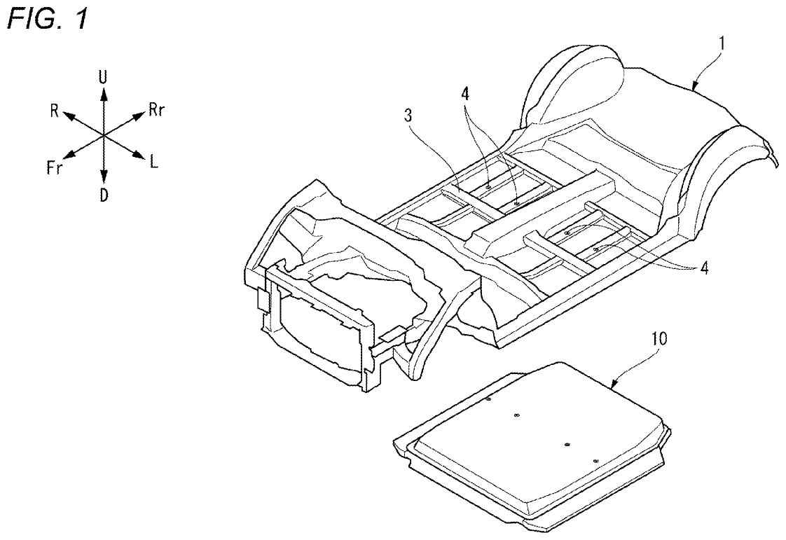

FIG. 1 is a perspective view of a battery pack 10 attached under a floor of a vehicle body 1. In the present embodiment, for example, the battery pack 10 is attached below a floor panel 3 of the vehicle body 1. A vehicle to which the battery pack 10 is attached is, for example, an electric vehicle such as a battery type electric automobile, a hybrid vehicle, or a fuel cell vehicle.

The floor panel 3 is provided with a plurality of (here, four) bolt holes 4 aligned in a left-right direction. The bolt hole 4 is a part of a fixing portion that fixes the battery pack 10 to the floor panel 3. The battery pack 10 is fixed to the floor panel 3 by inserting a bolt B3 in a bolt fixing portion 53 to be described later into the bolt hole 4 and fastening the bolt B3 to the bolt fixing portion 53.

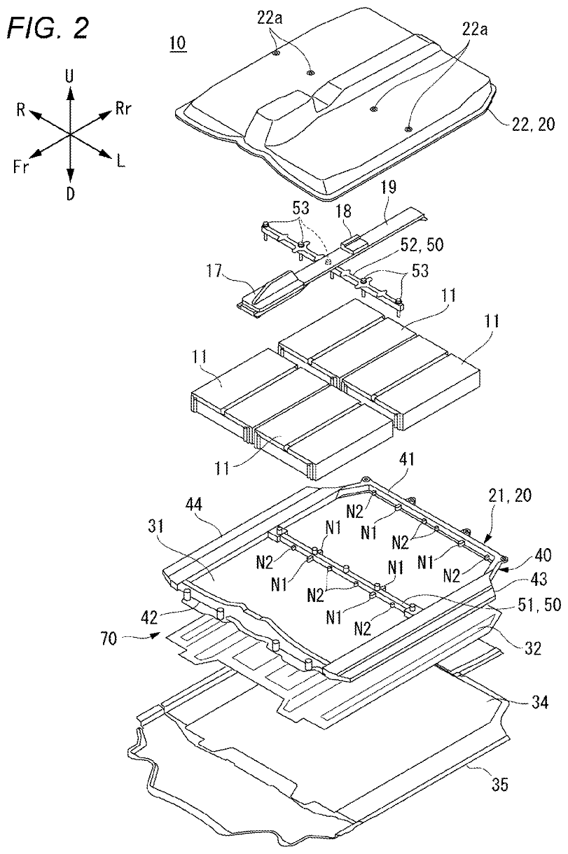

FIG. 2 is an exploded perspective view of the battery pack 10. The battery pack 10 includes four battery modules 11, a junction box 17, a battery electronic control unit (ECU) 18, a battery case 20 that accommodates these, and a water jacket 70.

### Battery Module

The four battery modules 11 are arranged in two rows in a front-rear direction and in two rows in the left-right direction. The four battery modules 11 are electrically connected to each other via an electrical connection member (for example, a bus bar) (not shown). The battery module 11 stores electric power to be supplied to a motor or the like serving as a drive source of the vehicle. The number of battery modules 11 can be set freely, and the arrangement is not particularly limited.

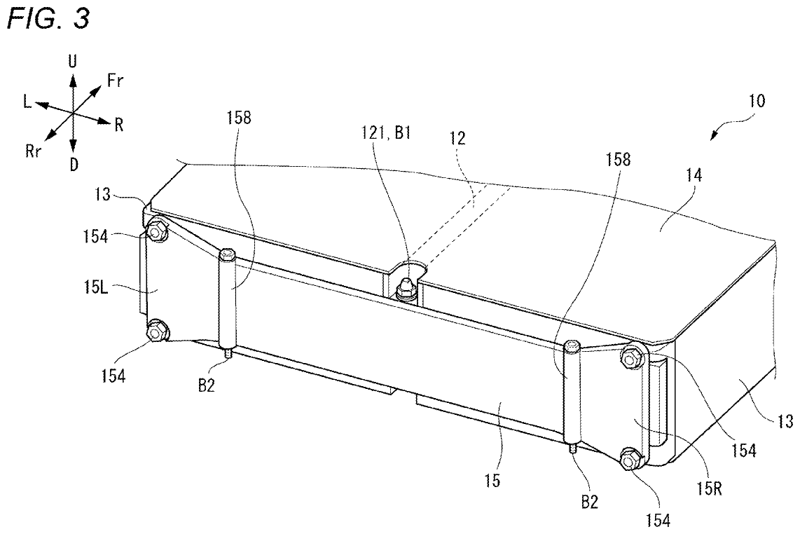

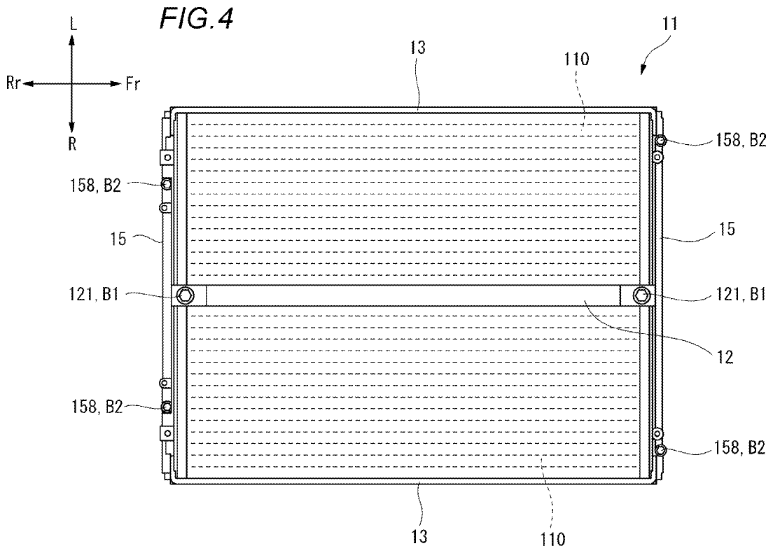

FIGS. 3 and 4 are a partial perspective view and a top view of the battery module 11, respectively. Each battery module 11 includes a plurality of battery cells 110, an intermediate plate 12, a pair of end plates 13, a pair of restraining members 14, and a pair of cover plates 15.

The battery cell 110 is, for example, a laminated cell made of a solid-state battery. In the present embodiment, the plurality of battery cells 110 are stacked in the left-right direction. The laminated cell includes a positive electrode to which a positive electrode tab is connected, a negative electrode to which a negative electrode tab is connected, a solid electrolyte disposed between the positive electrode and the negative electrode, and a laminate film accommodating these, and performs charging and discharging by transferring ions (for example, lithium ions) between the positive electrode and the negative electrode via a solid electrolyte. Each battery cell 110 is not limited to a laminated type, and may be a square or cylindrical type, and the electrolyte may be a liquid or a solid.

The intermediate plate 12 is provided at an intermediate portion in a stacking direction (here, the left-right direction) of the plurality of battery cells 110, and extends in a direction (here, the front-rear direction) orthogonal to the stacking direction. The intermediate plate 12 of the battery module 11 on a front side and the intermediate plate 12 of the battery module 11 on a rear side are provided at positions overlapping each other when viewed in the front-rear direction.

The intermediate plate 12 is a member having a load bearing capacity larger than that of the battery cell 110, and is an example of a load-bearing member according to the present invention. Each battery module 11 may include a plurality of intermediate plates 12.

In the intermediate plate 12, bolt holes 121 through which bolts B1 can be inserted from above are provided at both end portions in an extending direction (here, the front-rear direction). Each battery module 11 is fixed to the battery case 20 by fastening the bolts B1 inserted through the bolt hole 121 to battery fixing parts N1 and N3 of the cross member 50 and a battery fixing part N1 of the frame member 40, which will be described later.

The pair of end plates 13 are provided at both end portions in the stacking direction of the plurality of battery cells 110, and extend in a direction orthogonal to the stacking direction. The end plate 13 of the battery module 11 on the front side and the end plate 13 of the battery module 11 on the rear side are provided at positions overlapping each other when viewed in the front-rear direction.

Similarly to the intermediate plate 12, the pair of end plates 13 are members having a load bearing capacity larger than that of the battery cells 110, and are examples of the load-bearing member according to the present invention. As described above, each battery module 11 is provided with a plurality of load-bearing members (that is, the intermediate plate 12 and the pair of end plates 13) spaced apart from each other in the left-right direction.

The pair of restraining members 14 face each other in an upper-lower direction, and are connected to the pair of end plates 13 to restrain the plurality of battery cells 110. The pair of restraining members 14 has, for example, a plate shape, and covers the plurality of battery cells 110, the intermediate plate 12, and the pair of end plates 13 from the upper-lower direction.

The pair of cover plates 15 are provided outside the plurality of battery cells 110 in the front-rear direction and extend in the stacking direction. The cover plate 15 includes end plate connection portions 154 provided at a left end portion 15L and a right end portion 15R in a longitudinal direction and connected to the pair of end plates 13.

Bolt holes 158 through which bolts B2 can be inserted from above are provided between a central portion of the cover plate 15 in the left-right direction and the left end portion 15L and between a central portion thereof in the left-right direction and the right end portion 15R. Each battery module 11 is fixed to the battery case 20 by fastening the bolts B2 inserted through the bolt hole 158 to battery fixing parts N2 and N4 of the cross member 50 and the battery fixing part N2 of the frame member 40, which will be described later.

### Junction Box

Returning to FIG. 2, electronic components such as a conductive member, a fuse, and a comparator that connect an electric power system inside the battery case 20 and a DC line outside the battery case 20 are disposed in the junction box 17.

The junction box 17 is disposed on an upper surface of an upper frame 19 extending in the front-rear direction. The upper frame 19 is provided above the four battery modules 11 at the central portion of the battery case 20 in the left-right direction.

### Battery ECU

The battery ECU 18 is a control device that controls charging and discharging of the battery module 11, and includes a processor, a memory, an interface, and the like. The battery ECU 18 is disposed on the upper surface of the upper frame 19 at a position behind the junction box 17.

### Battery Case

The battery case 20 includes a case main body 21 and a cover 22 that covers the case main body 21 from above.

The case main body 21 has a tray shape, and the battery modules 11 are placed thereon. The case main body 21 includes a base plate 31, a water jacket plate 32, a frame member 40, and a cross member 50.

The battery modules 11 are placed on an upper surface of the base plate 31. The base plate 31 is a member extending in a horizontal direction, and is formed by pressing a metal material such as aluminum.

The water jacket plate 32 is joined to a lower surface of the base plate 31. Specifically, an outer edge portion of the water jacket plate 32 is joined to the lower surface of the base plate 31 by brazing or the like. The water jacket plate 32 is a member extending in the horizontal direction.

The water jacket 70 is formed between the base plate 31 and the water jacket plate 32. The details of the water jacket 70 and the water jacket plate 32 will be described later.

The frame member 40 is joined to an outer edge portion of the base plate 31 and constitutes an outer frame (that is, a rear wall, a front wall, a left wall, and a right wall) of the case main body 21. The frame member 40 is, for example, a cast aluminum material. Note that in the present embodiment, the base plate 31 and the frame member 40 are formed as separate members, but the present invention is not limited to this, and the base plate 31 and the frame member 40 may be formed integrally.

The frame member 40 includes a rear frame 41 provided at a rear edge portion of the base plate 31, a front frame 42 provided at a front edge portion of the base plate 31, and a pair of side frames 43 and 44 (also referred to as a left side frame 43 and a right side frame 44, respectively) provided at left and right edge portions of the base plate 31. The rear frame 41 and the front frame 42 extend in the left-right direction, and the pair of side frames 43 and 44 extend in the front-rear direction. The rear frame 41 and the front frame 42 are connected to a pair of side frames 43 and 44 by welding or the like.

The rear frame 41 and the front frame 42 are provided with battery fixing parts N1 and N2 for fixing the battery modules 11 to the battery case 20. In FIG. 2, the battery fixing parts N1 and N2 provided on the front frame 42 are not shown.

The cross member 50 extends in the left-right direction inside the battery case 20. The cross member 50 is provided in a central portion of the battery case 20 in the front-rear direction, and is disposed between the two battery modules 11 disposed on the front side and the two battery modules 11 disposed on the rear side. The cross member 50, together with the rear frame 41 and the front frame 42, supports a load input from the side of the battery pack 10 due to the collision, and protects the battery modules 11 placed inside the battery case 20.

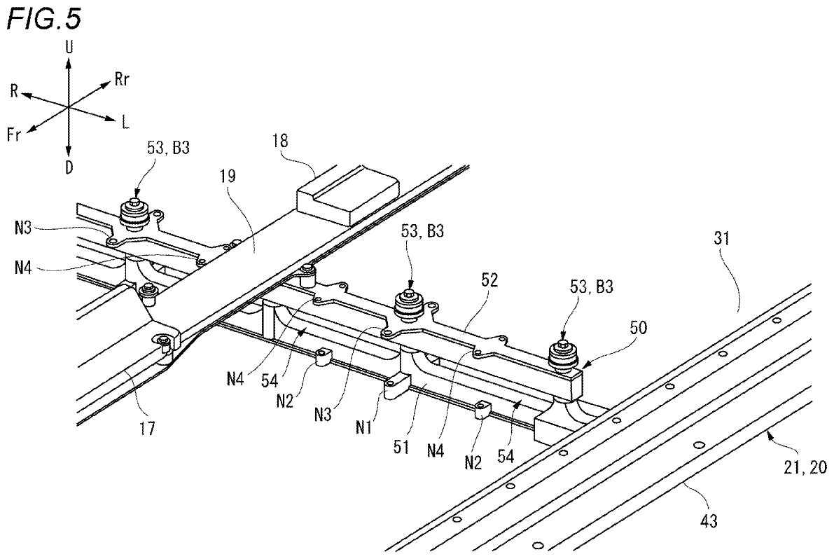

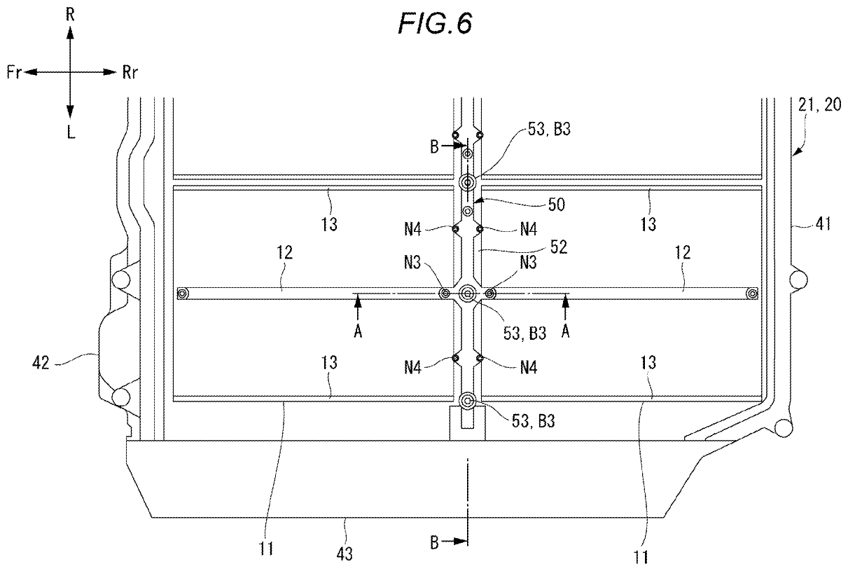

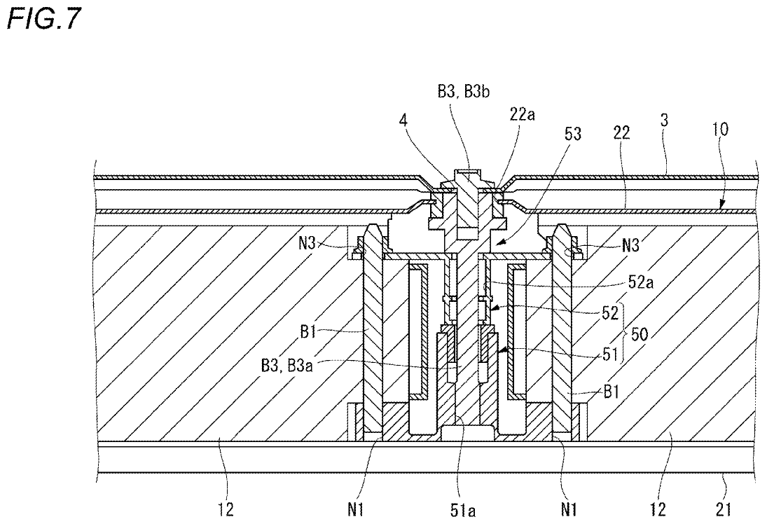

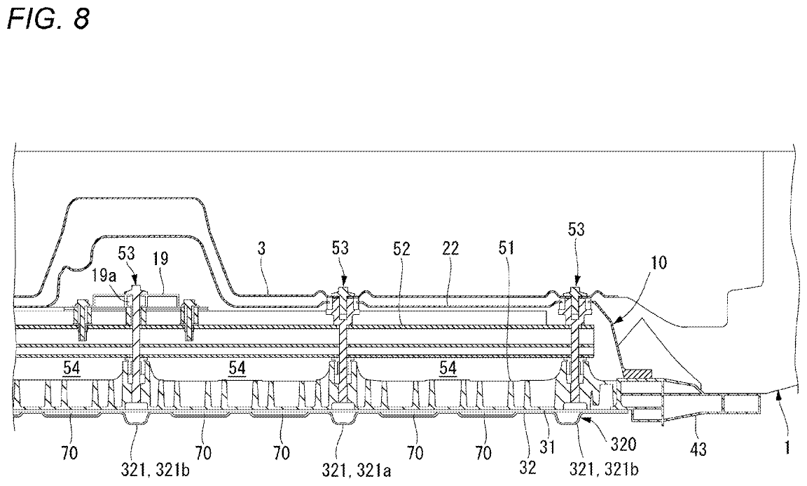

FIG. 5 is an enlarged perspective view of the cross member 50. FIG. 6 is a top view showing an arrangement relationship between the cross member 50 and the battery module 11 on the front side and the battery module 11 on the rear side. FIG. 7 is a cross-sectional view taken along a line A-A of FIG. 6. FIG. 8 is a cross-sectional view taken along a line B-B of FIG. 6.

The cross member 50 includes a lower cross member 51, an upper cross member 52, and a plurality of (five in the present embodiment) bolt fixing portions 53 that fix the lower cross member 51 and the upper cross member 52 to each other by the bolts B3.

The lower cross member 51 is provided to abut against the base plate 31 and extends in the left-right direction between the pair of side frames 43 and 44. The lower cross member 51 is disposed below the upper cross member 52 at a position overlapping the upper cross member 52 when viewed in the upper-lower direction. The lower cross member 51 is joined to the base plate 31 and the pair of side frames 43 and 44.

The lower cross member 51 includes a battery fixing part N1 that is fastened to the bolt B1 inserted into the bolt hole 121 of the intermediate plate 12 of each battery module 11, and battery fixing part N2 that is fastened to the bolts B2 inserted into the bolt holes 158 of the cover plate 15 of each battery module 11. The battery fixing parts N1 and N2 are provided on the front side and the rear side of the lower cross member 51.

The upper cross member 52 is attached to the upper side of the lower cross member 51. The upper cross member 52 includes a battery fixing part N3 to be fastened to the bolt B1 inserted into the bolt hole 121 of the intermediate plate 12 of each battery module 11, and battery fixing part N4 to be fastened to the bolts B2 inserted into the bolt holes 158 of the cover plate 15 of each battery module 11. The battery fixing parts N3 and N4 are provided on the front side and the rear side of the upper cross member 52.

The battery fixing part N1 of the lower cross member 51, the battery fixing part N3 of the upper cross member 52, and the bolt hole 121 of the intermediate plate 12 are provided at positions overlapping each other when viewed in the upper-lower direction, and the battery module 11 is fixed to the battery case 20 by inserting and fastening the bolts B1 through these.

Similarly, the battery fixing part N2 of the lower cross member 51, the battery fixing part N4 of the upper cross member 52, and the bolt hole 158 of the cover plate 15 are provided at positions overlapping each other when viewed in the upper-lower direction, and the battery module 11 is fixed to the battery case 20 by inserting and fastening the bolt B2 through these.

The battery fixing parts N1 and N3 are provided at positions overlapping the bolt fixing portions 53 when viewed in the front-rear direction. The battery fixing parts N2 and N4 are provided between adjacent bolt fixing portions 53.

In the present embodiment, although the battery module 11 is fixed to both the lower cross member 51 and the upper cross member 52, the present invention is not limited to this, and the battery module 11 may be fixed to only one of the lower cross member 51 and the upper cross member 52. That is, the battery fixing parts N1 and N2 of the lower cross member 51 may not be provided, or the battery fixing parts N3 and N4 of the upper cross member 52 may not be provided.

The upper frame 19 is attached to a central portion of the upper cross member 52 in the left-right direction.

The lower cross member 51 and the upper cross member 52 are spaced apart from each other at a position between the adjacent bolt fixing portions 53, and a hollowed out portion 54 is formed between the lower cross member 51 and the upper cross member 52. Thus, the weight of the battery pack 10 can be reduced. In addition, the configuration in which the cross member 50 includes the lower cross member 51 and the upper cross member 52 makes it possible to easily form the hollowed out portion 54 as compared with a case where the thinning process is performed on a cross member formed of one member.

The plurality of bolt fixing portions 53 are provided side by side in a direction (left-right direction) in which the cross member 50 extends. Each bolt fixing portion 53 is a portion of the battery case 20 where the load bearing capacity is large. The number of the bolt fixing portions 53 is any.

The bolt fixing portions 53 are disposed at positions overlapping the intermediate plates 12 or the end plates 13 of the battery modules 11 on the front and rear side when viewed in the front-rear direction.

As shown in FIG. 7, each bolt fixing portion 53 has a bolt hole 51a provided in the lower cross member 51 and a bolt hole 52a provided in the upper cross member 52. The bolt hole 51a of the lower cross member 51 and the bolt hole 52a of the upper cross member 52 are disposed at positions overlapping each other when viewed in the upper-lower direction. For example, a female screw is formed in the bolt hole 51a of the lower cross member 51, and each bolt fixing portion 53 fixes the lower cross member 51 and the upper cross member 52 to each other by fastening the bolt B3 inserted into the bolt holes 51a and 52a from above the upper cross member 52 to the bolt hole 51a, for example.

Each of the bolt fixing portions 53 is provided to abut against the base plate 31 of the case main body 21 around the bolt hole 51a of the lower cross member 51.

As shown in FIGS. 7 and 8, each bolt fixing portion 53 (except for the bolt fixing portion 53 at a center in the left-right direction) fixes the lower cross member 51 and the upper cross member 52 to the floor panel 3. Specifically, each bolt fixing portion 53 fixes the lower cross member 51 and the upper cross member 52 to the floor panel 3 by inserting the bolt B3 into the bolt hole 4 provided in the floor panel 3 and the bolt hole 22a provided in the cover 22 and fastening the bolt B3 to the bolt hole 51a of the lower cross member 51.

On the other hand, the bolt fixing portion 53 at the center in the left-right direction fixes the upper frame 19 to the upper cross member 52 by inserting the bolt B3 into a bolt hole 19a (see FIG. 8) formed in the upper frame 19.

Here, each bolt fixing portion 53 (except for the bolt fixing portion 53 at the center in the left-right direction) will be described in detail. The bolt B3 includes a lower bolt B3a and an upper bolt B3b. In the lower bolt B3a, a male screw to be fastened to the bolt hole 51a is formed in a distal end portion (lower end portion) of a screw portion, and a female screw to be fastened to the upper bolt B3b is formed in a head portion (upper end portion).

When the male screw of the lower bolt B3a is fastened to the bolt hole 51a, the lower cross member 51 and the upper cross member 52 are fixed to each other.

A part of the head portion of the lower bolt B3a is exposed from the bolt hole 22a of the cover 22, and the lower cross member 51 and the upper cross member 52 are fixed to the floor panel 3 by fastening the upper bolt B3b to the female screw formed in the head portion of the lower bolt B3a from above the bolt hole 4 of the floor panel 3.

Referring back to FIG. 2, a heat insulator 34 made of, for example, polypropylene foam is attached to the battery case 20 from below, and covers the water jacket 70 from below. Further, a lower cover 35 is attached to the battery case 20 from below the heat insulator 34. The lower cover 35 is formed of a lightweight member such as resin. In the drawings other than FIG. 2, the heat insulator 34 and the lower cover 35 are not shown.

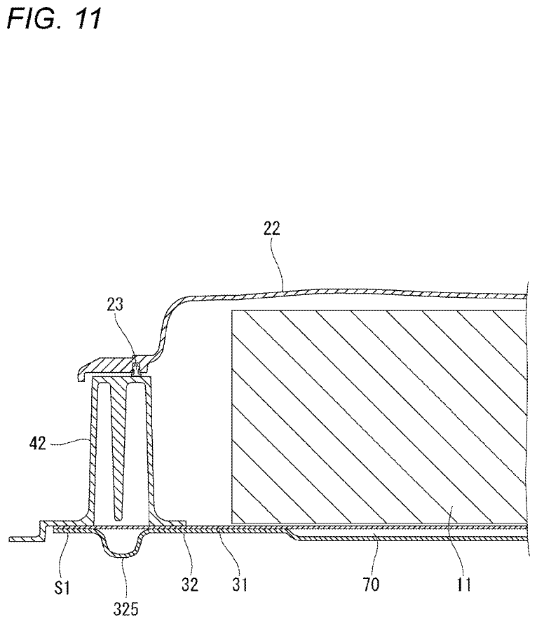

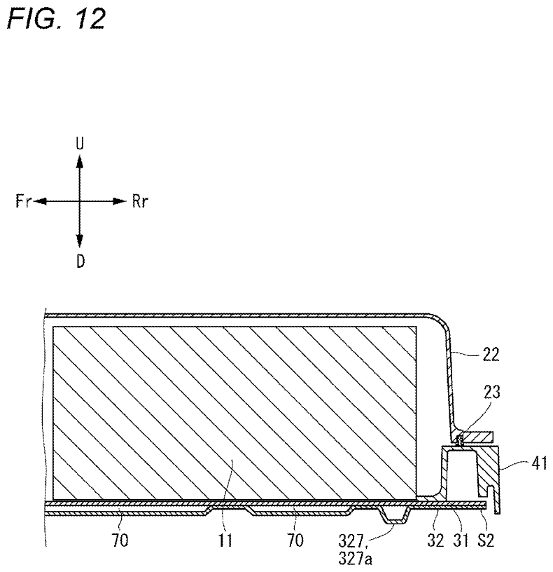

The cover 22 is attached to the frame member 40 from above. A sealing member 23 (for example, rubber foam, see FIGS. 11 and 12) is provided between an upper surface of the frame member 40 and an outer edge portion of the cover 22, and by attaching the cover 22 to the upper surface of the frame member 40, the inside of the battery case 20 is sealed. The cover 22 is attached to the frame member 40 by, for example, a bolt (not shown). Here, in a state where the cover 22 is attached, the battery module 11 side with respect to the sealing member 23 is defined as the inside of the battery case 20, and a side opposite to the battery module 11 with respect to the sealing member 23 is defined as the outside of the battery case 20.

### Water Jacket

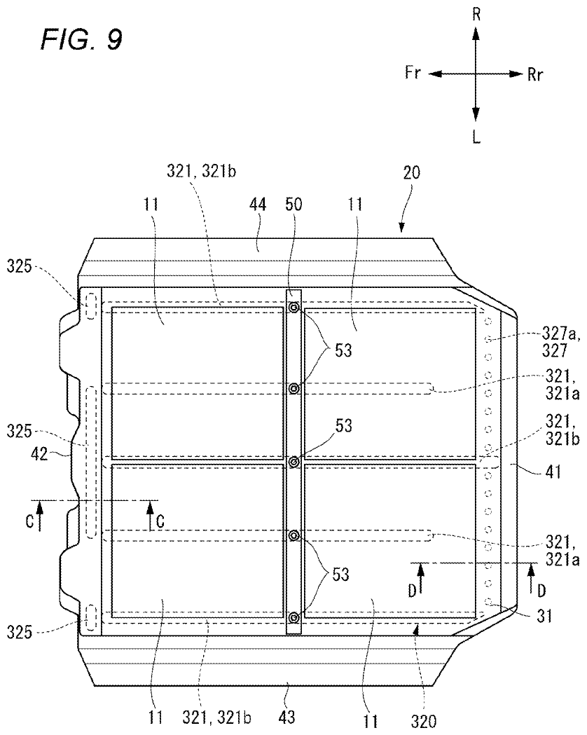

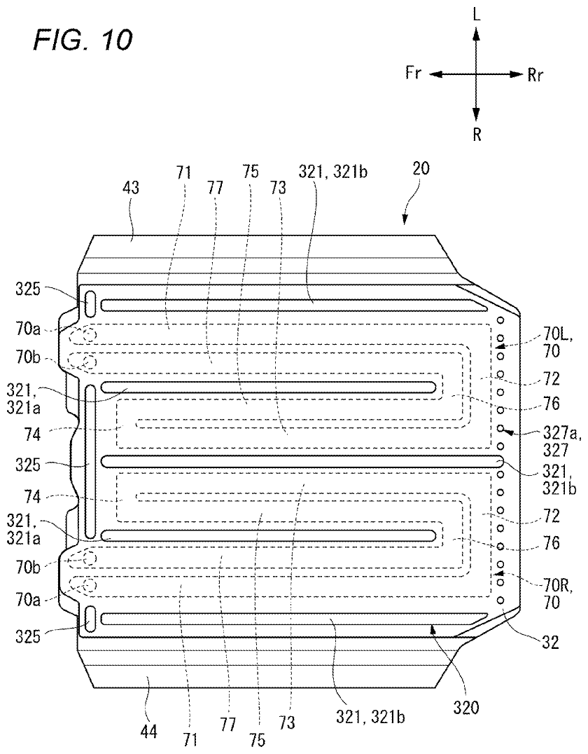

FIG. 9 is a top view of the battery pack 10 with the cover 22 removed. In FIG. 9, a protruding portion 320 to be described later is indicated by a broken line. FIG. 10 is a bottom view of the battery pack 10. In FIG. 10, the water jacket 70 is indicated by a broken line. A cross section of the water jacket 70 will be described with reference to FIG. 8.

As shown in FIGS. 2 and 8, the water jacket 70 is constituted by a flow path defined by the base plate 31 and the water jacket plate 32, and a coolant (for example, cooling water) for cooling the battery module 11 flows therein. In the present embodiment, although the flow path of the water jacket 70 is defined by providing unevenness on the water jacket plate 32, the present invention is not limited to this, and the base plate 31 may be provided with unevenness, or both the base plate 31 and the water jacket plate 32 may be provided with unevenness.

As shown in FIG. 10, in the present embodiment, the water jacket 70 includes a left water jacket 70L provided on the left side of the battery case 20 and a right water jacket 70R provided on the right side of the battery case 20. The left water jacket 70L and the right water jacket 70R have bilaterally symmetrical shapes.

A supply port 70a and a discharge port 70b are provided at a front end portion of each of water jackets 70L and 70R. A hose (not shown) is connected to the supply port 70a and the discharge port 70b, the coolant is supplied from the supply port 70a to each of the water jackets 70L and 70R, and the coolant is discharged from the discharge port 70b to the outside.

Each of the water jackets 70L and 70R has a plurality of flow paths 71, 73, 75, and 77 extending in the front-rear direction and a plurality of flow paths 72, 74, and 76 extending in the left-right direction. The flow path 71 has the supply port 70a at a front end and extends from the supply port 70a along a left edge portion or a right edge portion of the water jacket plate 32. The flow path 73 extends in a central portion of the water jacket plate 32 of the flow path 71. The flow path 71 and the flow path 73 are connected by the flow path 72 at rear ends thereof. The flow path 75 and the flow path 77 are provided between the flow path 71 and the flow path 73, the flow path 75 is provided next to the flow path 73, and the flow path 77 is provided next to the flow path 71. The flow path 73 and the flow path 75 are connected to the flow path 74 at the front ends thereof. The flow path 75 and the flow path 77 are connected to the flow path 76 at the rear ends thereof. The flow path 77 has the discharge port 70b at a front end thereof.

### Protruding Portion of Bottom Surface of Battery Case

A bottom surface of the battery case 20, that is, the water jacket plate 32 is provided with a plurality of protruding portions 320 protruding downward. The plurality of protruding portions 320 are integrally provided on the water jacket plate 32. Hereinafter, the plurality of protruding portions 320 will be described with reference to FIGS. 8 to 13.

As shown in FIGS. 9 and 10, the protruding portion 320 includes first protruding portions 321 extending continuously in the front-rear direction, second protruding portions 325 provided at a front end portion of the water jacket plate 32, and third protruding portions 327 provided at a rear end portion of the water jacket plate 32.

The protruding portion 320 (that is, the first protruding portion 321, the second protruding portion 325, and the third protruding portion 327) protrudes below the water jacket 70 (see FIG. 8). Accordingly, for example, when an object such as a curb collides with the battery pack 10 from below and a load is input, the load is input to the protruding portion 320 before the load is input to the water jacket 70. Thus, the water jacket 70 can be protected. The protruding portion 320 may have the same amount of protrusion as the water jacket 70, that is, a lower end position of the protruding portion 320 may match a lower end position of the water jacket 70 in the upper-lower direction.

A plurality of (five in the present embodiment) first protruding portions 321 are provided side by side in the left-right direction. A front end portion of each first protruding portions 321 is located forward of the cross member 50, and a rear end portion thereof is located rearward of the cross member 50. Each first protruding portion 321 is provided so as to intersect with the cross member 50 when viewed in the upper-lower direction. In the present embodiment, although each first protruding portion 321 is provided linearly in the front-rear direction when viewed in the upper-lower direction, the present invention is not limited to this, and may be provided in a curved shape (for example, a wave shape) when viewed in the upper-lower direction.

Each first protruding portion 321 intersects the cross member 50 at a position overlapping the bolt fixing portion 53 of the cross member 50 when viewed in the upper-lower direction. The bolt fixing portion 53 is a portion of the battery case 20 where the load bearing capacity is large, in other words, each first protruding portion 321 intersects the cross member 50 at a position overlapping the portion where the load bearing capacity is large when viewed in the upper-lower direction.

When an object such as a curbstone collides with the battery pack 10 from below, a load is input to the first protruding portion 321 protruding below the bottom surface of the battery case 20. The load received by the first protruding portion 321 is supported by the bolt fixing portion 53 and the lower cross member 51 and the upper cross member 52 fixed to the bolt fixing portion 53. Thus, the battery module 11 can be protected from a load input from below the battery pack 10.

Since the first protruding portion 321 is provided integrally with the water jacket plate 32, it is not necessary to provide, for example, a high-strength metal protection plate below the water jacket plate 32 in order to protect the battery module 11 and the water jacket 70, and the number of parts can be reduced. In addition, it is not necessary to form the base plate 31 and the water jacket plate 32 to be thick, and to form the lower cover 35 made of resin to be made of metal having high strength, and reduction in weight can be achieved. As described above, both protection of the battery module 11 and reduction in the number of parts or weight of the battery pack 10 can be achieved.

As described above, since the bolt fixing portion 53 fixes the lower cross member 51 and the upper cross member 52 to the floor panel 3, the load received by the first protruding portion 321 due to the collision of the object from below can be further supported by the floor panel 3 in addition to the bolt fixing portion 53, the lower cross member 51, and the upper cross member 52.

As described above, the lower cross member 51 and the upper cross member 52 are fixed to the intermediate plate 12 having a large load bearing capacity in the battery module 11 at the battery fixing parts N1 and N3. Accordingly, the load received by the first protruding portion 321 due to the collision of the object from below can be transmitted to the intermediate plate 12 via the bolt fixing portion 53, the lower cross member 51, and the upper cross member 52. Thus, the load bearing capacities of the bolt fixing portion 53, the lower cross member 51, and the upper cross member 52 can be increased.

As described above, the battery fixing parts N1 and N3, which are fixing portions of the lower cross member 51 and the upper cross member 52 to the intermediate plate 12, are provided at positions overlapping the bolt fixing portions 53 of the cross member 50 when viewed in the front-rear direction. Accordingly, since a transmission path of the load from the bolt fixing portion 53 to the intermediate plate 12 is shortened, the load received by the first protruding portion 321 due to the collision of the object from below can be transmitted to the intermediate plate 12 more efficiently.

Here, the first protruding portion 321 will be described in detail. The five first protruding portions 321 include two first protruding portions 321a provided at positions overlapping the intermediate plates 12 of the two battery modules 11 arranged side by side in the front-rear direction, and three first protruding portions 321b provided at positions overlapping the end plates 13 of the two battery modules 11 arranged side by side in the front-rear direction, when viewed in the upper-lower direction.

Since each first protruding portion 321a is disposed directly below the intermediate plate 12 of the battery module 11, even when an upward load is applied to the first protruding portion 321a, the load can be received by the intermediate plate 12 having a large load bearing capacity. Thus, the battery cell 110 can be protected.

A length of each first protruding portion 321a in the front-rear direction is longer than a length of the intermediate plate 12 of each battery module 11 in the front-rear direction, and each first protruding portion 321a is provided below the intermediate plate 12 of the battery module 11 on the front side and the intermediate plate 12 of the battery module 11 on the rear side. Thus, when a load input from below the battery pack 10 is received by the first protruding portion 321a, the load can be dispersed in the front-rear direction and received by the intermediate plate 12.

Since each first protruding portion 321b is disposed directly below the end plate 13 of the battery module 11, even when an upward load is applied to the first protruding portion 321b, the load can be received by the end plate 13 having a large load bearing capacity. Thus, the battery cell 110 can be protected.

A length of each first protruding portion 321b in the front-rear direction is longer than a length of the end plate 13 of each battery module 11 in the front-rear direction, and each first protruding portion 321b is provided below the end plate 13 of the battery module 11 on the front side and the end plate 13 of the battery module 11 on the rear side. Accordingly, when the load input from below the battery pack 10 is received by the first protruding portion 321b, the load can be dispersed in the front-rear direction and received by the end plate 13.

Since each plurality of first protruding portion 321 is disposed at a position overlapping the corresponding intermediate plate 12 or the end plate 13 when viewed in the upper-lower direction, a load input from below the battery pack 10 can be received by the plurality of first protruding portions 321 and supported by the intermediate plate 12 and/or the end plate 13 regardless of the position in the left-right direction.

The second protruding portion 325 extends in the left-right direction and is provided at the front end portion of the water jacket plate 32. As described above, the supply port 70a and the discharge port 70b are provided at the front end portion of each of the water jackets 70L and 70R, and the second protruding portion 325 is provided discontinuously in the vicinity of the supply port 70a and the discharge port 70b.

FIG. 11 is a cross-sectional view taken along a line C-C of FIG. 9. The second protruding portion 325 is provided at a position overlapping the front frame 42 when viewed in the upper-lower direction. According to this configuration, the load input from below the battery pack 10 and received by the second protruding portion 325 can be further supported by the front frame 42.

Front end portions of the base plate 31 and the water jacket plate 32 have a front crush stroke portion S1 that extends further outward (herein, frontward) of the battery case 20 than the second protruding portion 325. When a load in a horizontal direction is applied from the front of the battery pack 10, the base plate 31 and the water jacket plate 32 support the load against a relatively small load, and the front crush stroke portion S1 absorbs the load while deforming against a relatively large load. This protects the battery modules 11 disposed inside the battery case 20.

Referring back to FIGS. 9 and 10, the third protruding portion 327 is provided at the rear end portion of the water jacket plate 32 and includes a plurality of protrusions 327a protruding downward. The plurality of protrusions 327a are provided side by side in the left-right direction, and the adjacent protrusions 327a are provided at predetermined intervals.

FIG. 12 is a cross-sectional view taken along a line D-D of FIG. 9. The rear end portions of the base plate 31 and the water jacket plate 32 have a rear crush stroke portion S2 that extends further outward (herein, rearward) of the battery case 20 than the third protruding portion 327. When a load in a horizontal direction is applied from the rear of the battery pack 10, the base plate 31 and the water jacket plate 32 support the load against a relatively small load, and the rear crush stroke portion S2 absorbs the load while deforming against a relatively large load. This protects the battery modules 11 disposed inside the battery case 20.

Since the third protruding portion 327 includes the plurality of protrusions 327a, a horizontal portion between the adjacent protrusions 327a can also receive a load in the horizontal direction from the rear. Accordingly, it is possible to improve the load bearing capacity in the horizontal direction at the rear end portions of the base plate 31 and the water jacket plate 32.

In the present embodiment, the third protruding portion 327 is provided between the rear frame 41 and the water jacket 70 in the front-rear direction.

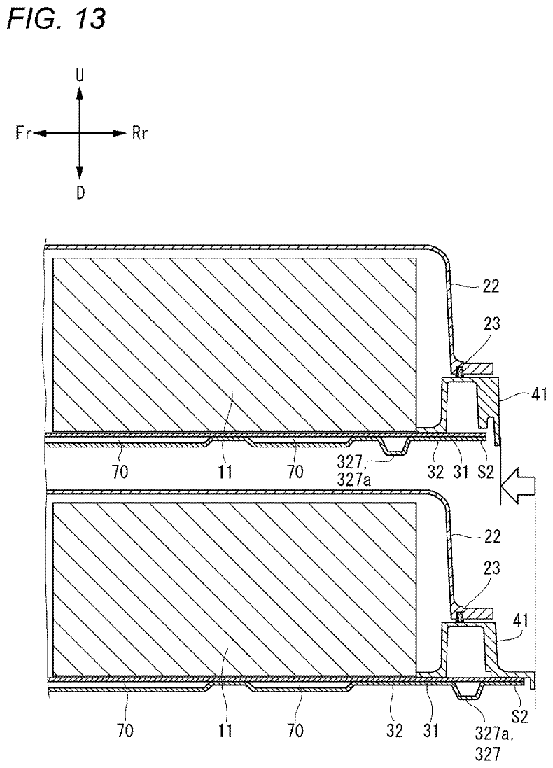

FIG. 13 shows the present embodiment (upper stage) in which the third protruding portion 327 is provided between the water jacket 70 and the rear frame 41, and a comparative example (lower stage) in which the third protruding portion 327 is provided directly below the rear frame 41. In the comparative example, an outside portion of the battery case 20 (that is, the rear side of the sealing member 23) becomes longer due to the presence of the third protruding portion 327 provided directly below the rear frame 41 and the rear crush stroke portion S2. On the other hand, in the present embodiment, since the third protruding portion 327 is not provided directly below the rear frame 41, a portion of the rear crush stroke portion S2 outside the battery case 20 can be shortened. Thus, the battery pack 10 can be made compact in the front-rear direction.

Although one embodiment of the present invention has been described above with reference to the accompanying drawings, it is needless to say that the present invention is not limited to the embodiment. It is apparent to those skilled in the art that various changes or modifications can be conceived within the scope described in the claims, and it is understood that the changes or modifications naturally fall within the technical scope of the present invention. In addition, the constituent elements in the above embodiment may be freely combined without departing from the gist of the invention.

For example, in the embodiment described above, the cross member 50 and the intermediate plate 12, which is the example of the load-bearing member, are fixed to each other, but the present invention is not limited thereto. For example, instead of or in addition to the fixing between the cross member 50 and the intermediate plate 12, a fixing portion to the cross member 50 may be provided in the end plate 13 which is another example of the load-bearing member, and the cross member 50 and the end plate 13 may be fixed.

In the embodiment described above, the second protruding portion 325 is provided at a position overlapping the front frame 42 when viewed in the upper-lower direction, but the present invention is not limited thereto. For example, similarly to the third protruding portion 327, the second protruding portion 325 may be provided between the water jacket 70 and the front frame 42 when viewed in the upper-lower direction. Similarly to the third protruding portion 327, the second protruding portion 325 may include a plurality of protrusions arranged side by side in the left-right direction.

In the embodiment described above, the third protruding portion 327 is provided between the water jacket 70 and the rear frame 41 when viewed in the upper-lower direction, but the present invention is not limited thereto. For example, similarly to the second protruding portion 325, the third protruding portion 327 may be provided between the water jacket 70 and the rear frame 41 when viewed in the upper-lower direction.

In the present specification, at least the following matters are described. In the parentheses, the corresponding constituent elements and the like in the above embodiment are shown as an example, but the present invention is not limited thereto.

(1) A battery pack (battery pack 10) to be attached under a floor of a vehicle body (vehicle body 1), including:
battery modules (battery modules 11) each including a plurality of battery cells (battery cells 110) stacked in a first direction (left-right direction) in a horizontal direction, the battery modules being arranged side by side at least two in a second direction (front-rear direction) orthogonal to the first direction in the horizontal direction; and
a case (battery case 20) accommodating the battery modules, in which the case includes:
   a case main body (case main body 21) on which the battery modules are placed; and
   a cross member (cross member 50) extending in the first direction inside the case and provided between at least two of the battery modules arranged side by side in the second direction,
the cross member includes:
   an upper cross member (upper cross member 52);
   a lower cross member (lower cross member 51) disposed below the upper cross member at a position overlapping the upper cross member when viewed in an upper-lower direction; and
   a fixing portion (bolt fixing portion 53) abutting against a bottom surface of the case main body and fixing the upper cross member and the lower cross member to each other by a fastening member (bolt B3),
the bottom surface of the case main body is integrally provided with at least one first protruding portion (first protruding portion 321) that protrudes downward and extends continuously in the second direction, and
the first protruding portion intersects the cross member at a position overlapping the fixing portion of the cross member when viewed in the upper-lower direction.

According to (1), since the first protruding portion provided on the bottom surface of the case intersects the cross member at a position overlapping the fixing portion of the cross member when viewed in the upper-lower direction, a load input from below the battery pack and received by the first protruding portion can be supported by the fixing portion, the upper cross member, and the lower cross member. Accordingly, the battery modules can be protected from the load input from below the battery pack. Further, since the first protruding portion is integrally provided on the bottom surface of the case main body, both protection of the battery modules and reduction in the number of parts or weight can be achieved.

In the embodiment described above, although the first direction has been described as the left-right direction and the second direction as the front-rear direction, the first direction may be the front-rear direction, and the second direction may be the left-right direction.

(2) The battery pack according to (1), wherein
the fixing portion of the cross member fixes the upper cross member and the lower cross member to a floor panel (floor panel 3).

According to (2), the load input from below the battery pack and received by the first protruding portion can be further supported by the floor panel.

(3) The battery pack according to (1) or (2), wherein
each battery module includes a load-bearing member (intermediate plate 12, end plate 13) extending in the second direction and having a load bearing capacity larger than that of the battery cell, and
at least one of the upper cross member and the lower cross member is fixed to the load-bearing member.

According to (3), the load input from below the battery pack and received by the first protruding portion can be transmitted to the load-bearing member of the battery module via the fixing portion of the cross member and at least one of the upper cross member and the lower cross member.

(4) The battery pack according to (3), wherein
a fixing part (battery fixing parts N1, N3) between at least one of the upper cross member and the lower cross member and the load-bearing member is provided at a position overlapping the fixing portion of the cross member when viewed from the second direction.

According to (4), since a transmission path of the load from the fixing portion of the cross member to the load-bearing member of the battery module is shortened, the load input from below the battery pack and received by the first protruding portion can be transmitted to the load-bearing member more efficiently.

(5) The battery pack according to any one of (1) to (4), further including:
a water jacket (water jacket 70) configured to allow a coolant for cooling the battery module to flow therethrough, wherein
the case main body includes:
   a base plate (base plate 31) on which the battery modules are placed;
   a water jacket plate (water jacket plate 32) that is joined to a lower surface of the base plate to form the water jacket between the water jacket plate and the base plate; and
   a frame member (frame member 40) that is joined to an outer edge portion of the base plate and constitutes an outer frame of the case,
a second protruding portion (second protruding portion 325) extending in the first direction is provided on a lower surface of the water jacket plate, and
the second protruding portion
   protrudes below the water jacket, protrudes to a position in the upper-lower direction same as a lower end of the water jacket, and
   is provided at a position overlapping the frame member when viewed in the upper-lower direction.

According to (5), when a load is input from below the battery pack, the load is received by the second protruding portion, and therefore the water jacket can be protected. Further, since the second protruding portion is disposed at a position overlapping the frame member when viewed in the upper-lower direction, the load input from below the battery pack and received by the second protruding portion can be supported by the frame member.

(6) The battery pack according to any one of (1) to (5), further including:
a water jacket (water jacket 70) configured to allow a coolant for cooling the battery module to flow therethrough, wherein
the case main body includes:
   a base plate (base plate 31) on which the battery modules are placed;
   a water jacket plate (water jacket plate 32) that is joined to a lower surface of the base plate to form the water jacket between the water jacket plate and the base plate; and
   a frame member (frame member 40) that is joined to an outer edge portion of the base plate and constitutes an outer frame of the case,
a third protruding portion (third protruding portion 327) protruding downward is provided on a lower surface of the water jacket plate, and
the third protruding portion includes a plurality of protrusions (protrusions 327a) arranged side by side in the first direction, the plurality of protrusions protrudes below the water jacket or protrudes to a position in the upper-lower direction same as a lower end of the water jacket in the upper-lower direction.

According to (6), when a load is input from below the battery pack, the load is received by the third protruding portion, and therefore the water jacket can be protected. Further, since the third protruding portion includes the plurality of protrusions arranged side by side, a load in a direction parallel to the base plate and the water jacket plate can be received at a portion between the adjacent protrusions.

(7) The battery pack according to (6), wherein
the plurality of protrusions is provided between the frame member and the water jacket in the second direction.

According to (7), it is not necessary to extend a crush stroke portion from distal end portions of the base plate and the water jacket plate to the plurality of protrusions to the outside of the case, and thus the battery pack can be made compact.

(8) The battery pack according to any one of (1) to (7), wherein
each battery module includes at least one load-bearing member (intermediate plate 12, end plate 13) extending in the second direction and having a load bearing capacity larger than that of the battery cell,
the at least one load-bearing members of at least two of the battery modules arranged side by side in the second direction are arranged at positions overlapping each other when viewed from the second direction,
the first protruding portion is provided at a position overlapping the at least one load-bearing members of the at least two of the battery modules arranged side by side in the second direction when viewed in the upper-lower direction, and
a length of the first protruding portion in the second direction is longer than a length of the at least one load-bearing member of each battery module in the second direction.

According to (8), the load input from below the battery pack and received by the first protruding portion can be supported by the load-bearing member of the battery module. Further, since the length of the first protruding portion in the second direction is longer than the length of the load-bearing member of each battery module in the second direction, the load received by the first protruding portion can be dispersed in the second direction, and even when a larger load is input, the load can be supported by the load-bearing member.

(9) The battery pack according to (8), wherein
the at least one load-bearing member of each battery module includes a plurality of load-bearing members spaced apart from each other in the first direction,
the first protruding portion includes a plurality of first protruding portions arranged side by side in the first direction on a bottom surface of the case, and
each of the plurality of first protruding portions (first protruding portions 321a, 321b) is provided at position overlapping corresponding one of the plurality of load-bearing members when viewed in the upper-lower direction.

According to (9), since the plurality of first protruding portions are provided in the first direction and are disposed at positions overlapping the corresponding load-bearing members, the load input from below the battery pack can be supported by the first protruding portions regardless of the position in the first direction.

What is claimed is:

1. A battery pack to be attached under a floor of a vehicle body, comprising:
battery modules each including a plurality of battery cells stacked in a first direction in a horizontal direction, the battery modules being arranged side by side at least two in a second direction orthogonal to the first direction in the horizontal direction; and
a case accommodating the battery modules, wherein
the case includes:
a case main body on which the battery modules are placed; and
a cross member extending in the first direction inside the case and provided between at least two of the battery modules arranged side by side in the second direction,
the cross member includes:
an upper cross member;
a lower cross member disposed below the upper cross member at a position overlapping the upper cross member when viewed in an upper-lower direction; and
a fixing portion abutting against a bottom surface of the case main body and fixing the upper cross member and the lower cross member to each other by a fastening member,
the bottom surface of the case main body is integrally provided with at least one first protruding portion that protrudes downward and extends continuously in the second direction, and
the first protruding portion intersects the cross member at a position overlapping the fixing portion of the cross member when viewed in the upper-lower direction.

2. The battery pack according to claim 1, wherein
the fixing portion of the cross member is configured to fix the upper cross member and the lower cross member to a floor panel.

3. The battery pack according to claim 1, wherein
each battery module includes a load-bearing member extending in the second direction and having a load bearing capacity larger than that of the battery cell, and
at least one of the upper cross member and the lower cross member is fixed to the load-bearing member.

4. The battery pack according to claim 3, wherein
a fixing part between at least one of the upper cross member and the lower cross member and the load-bearing member is provided at a position overlapping the fixing portion of the cross member when viewed from the second direction.

5. The battery pack according to claim 1, further comprising:
a water jacket configured to allow a coolant for cooling the battery modules to flow therethrough, wherein
the case main body includes:
a base plate on which the battery modules are placed;
a water jacket plate that is joined to a lower surface of the base plate to form the water jacket between the water jacket plate and the base plate; and
a frame member that is joined to an outer edge portion of the base plate and constitutes an outer frame of the case,
a second protruding portion extending in the first direction is provided on a lower surface of the water jacket plate, and
the second protruding portion
protrudes below the water jacket or protrudes to a position in the upper-lower direction same as a lower end of the water jacket, and
is provided at a position overlapping the frame member when viewed in the upper-lower direction.

6. The battery pack according to claim 1, further comprising:
a water jacket configured to allow a coolant for cooling the battery modules to flow therethrough, wherein
the case main body includes:
a base plate on which the battery modules are placed;
a water jacket plate that is joined to a lower surface of the base plate to form the water jacket between the water jacket plate and the base plate; and
a frame member that is joined to an outer edge portion of the base plate and constitutes an outer frame of the case,
a third protruding portion protruding downward is provided on a lower surface of the water jacket plate, and
the third protruding portion includes a plurality of protrusions arranged side by side in the first direction, the plurality of protrusions protrudes below the water jacket or protrudes to a position in the upper-lower direction same as a lower end of the water jacket.

7. The battery pack according to claim 6, wherein
the plurality of protrusions is provided between the frame member and the water jacket in the second direction.

8. The battery pack according to claim 1, wherein
each battery module includes at least one load-bearing member extending in the second direction and having a load bearing capacity larger than that of the battery cell,
the at least one load-bearing members of at least two of the battery modules arranged side by side in the second direction are arranged at positions overlapping each other when viewed from the second direction,
the first protruding portion is provided at a position overlapping the at least one load-bearing members of the at least two of the battery modules arranged side by side in the second direction when viewed in the upper-lower direction, and
a length of the first protruding portion in the second direction is longer than a length of the at least one load-bearing member of each battery module in the second direction.

9. The battery pack according to claim 8, wherein
the at least one load-bearing member of each battery module includes a plurality of load-bearing members spaced apart from each other in the first direction,
the first protruding portion includes a plurality of first protruding portions arranged side by side in the first direction on a bottom surface of the case, and
each of the plurality of first protruding portions is provided at position overlapping corresponding one of the plurality of load-bearing members when viewed in the upper-lower direction.
